(19) United States
(12) Patent Application Publication
(10) Pub. No.: US 2005/0160472 A1
(43) Pub. Date: Jul. 21, 2005

(54) Method for using a delivery system descriptor so that a receiver automatically can modify itself, if the broadband transmission delivery parameters changes

(75) Inventor: Berth Axelsson, Mantorp (SE)

Correspondence Address: BANNER & WITCOFF, 1001 G STREET N W, SUITE 1100, WASHINGTON, DC, 20001, US

(73) Assignee: NOKIA CORPORATION, Espoo (FI)

(21) Appl. No.: 10/505,978

(22) PCT Filed: Feb. 27, 2003
(86) PCT No.: PCT/FI03/00141

(30) Foreign Application Priority Data
Feb. 28, 2002 (FI) 20020389

(51) Int. Cl. H04N 7/173

(52) U.S. Cl. 725/118; 725/105; 725/126

(57) ABSTRACT

A method and system for identifying the delivery system and physical properties of the satellite delivery system is presented. A Delivery System Descriptor is used as a descriptor and the DSID is referred to in a Network Information Table (NIT). The DSID identifies the type of the delivery system (Satellite, Cable, Terrestrial), a band the satellite is transmitting and the position in which the satellite appears on the sky. The NIT is contained in the Service Information (SI). The receiver can automatically modify itself for a reception with different parameters. Also, the user can configure the receiver device for the reception with other parameters than currently applied. The discovery of the satellite delivery system parameters does not require a use of the interaction network. Also simple user friendly configurations are required in the receiver device.

### TECHNICAL FIELD OF THE INVENTION

This invention relates to systems and methods for distributing data over a communication link.

### BACKGROUND OF THE INVENTION

Broadcast has an almost century long tradition in radio. Even with TV, the history goes back to 1930's. Broadcasting has been successful throughout the world in bringing both entertainment and information to mass audiences.

The latest step in broadcasting is the digitalization of both radio and TV. Digital radio has not gained much acceptance on the market. However, many hope that digital TV will bring new benefits and services to the consumer and, as a result, generate new revenue streams for the broadcasting industry. The basic concept of the TV service itself has, however, not changed much. Rather, the TV lives on as before even if it has become digital.

In later half of 1990's we saw the boom of the Internet. A whole set of new services and content became available to the consumers during a short, revolutionary and hype intense period. That period introduced e-commerce, Internet Service Providers (ISPs), Portals, eyeballs game, dotcom companies and even the new economy. The developments in both access technologies (e.g. ADSL) and coding technologies (e.g. MPEG-2 streaming) has made it possible to bring rich media content like video content to homes via the Internet. Despite of these technology and market break-throughs media houses have been reluctant to distribute their content via the Internet due to its “free-of-charge” nature and the direct threat of piracy. Neither has Internet been able to challenge the role of traditional media as the primary advertisement platform despite its great popularity.

Broadcast provides the receiver device with huge amount of information. The receiver device needs to know a delivery way for obtaining services via a delivery system.

In some previous approaches for obtaining the broadcast service, the manufacturer of the receiver has always had to know the delivery way to be applied. Moreover, an attempt to alter the delivery way has had to be made by the manufacturer by a difficult and complex software upgrade of the receiver. This has been annoying when an alteration in the delivery way has taken place, for example, new satellite has been launched, or two satellites with different parameters are at the same position.

### SUMMARY OF THE INVENTION

Now a method and arrangement has been invented where a unique and the same delivery identification is applied for obtaining a service that is transferred over a data link.

In accordance with a first aspect of the invention there is provided a method for identifying a delivery way for a broadcast transmission delivering services, the method comprising the steps of:

comparing a delivery system identifier with parameters stored in a receiver for receiving the broadcast transmission, wherein the delivery system identifier uniquely identifies the delivery way and reception parameters for a certain delivery way, and

adapting a reception of the broadcast transmission to the delivery way identified by the delivery system identifier in accordance with the comparing step.

In accordance with a second aspect of the invention there is provided a receiver for identifying a delivery way for a broadcast transmission delivering services, the receiver comprising:

means for comparing a delivery system identifier with parameters stored in a receiver for receiving the broadcast transmission, wherein the delivery system identifier uniquely identifies the delivery way and reception parameters for a certain delivery way, and

means for adapting a reception of the broadcast transmission to the delivery way identified by the delivery system identifier in accordance with the comparing.

In accordance with a third aspect of the invention there is provided a system for identifying a delivery way of a broadcast transmission delivering services, the system comprising:

delivery systems for transmitting the broadcast transmission of the services,

at least one receiver for catching the broadcast transmission from a certain delivery system in a certain way, and

means for adapting the receiver to a delivery system identifier, wherein the delivery system identifier uniquely identifies the delivery system and reception parameters for the certain way.

In accordance with a fourth aspect of the invention there is provided a computer program product comprising a program of instructions executable by a computing system for processing an identification of the delivery way for broadcast transmission delivering services, the computer program product comprising:

computer program code for causing the system to compare a delivery system identifier with parameters stored in a receiver for receiving the broadcast transmission, wherein the delivery system identifier uniquely identifies the delivery way and reception parameters for a certain delivery way, and

computer program code for causing the system to adapt a reception of the broadcast transmission to the delivery way identified by the delivery system identifier in accordance with the comparing.

### BRIEF DESCRIPTION OF THE DRAWINGS

The invention will now be described, by way of example only, with reference to the accompanying drawings, in which:

FIG. 1 shows an example of Digital broadcasting service delivery model,

FIG. 2 shows an example of identifier hierarchy in the service delivery system in accordance with an embodiment of the invention,

FIG. 3 shows a Delivery System Identifier bit line for bundling up the possibly changes of the delivery system or alterations in the delivery system in accordance with a further embodiment of the invention,

FIG. 4 depicts in a form of a flowchart a method for identifying a delivery by receiving the DSID from a digital broadcast network in accordance with an embodiment of the invention,

FIG. 5 depicts in a form of a flowchart a method for identifying a delivery by receiving the DSID in a digital broadcast receiver device in accordance with a further embodiment of the invention,

FIG. 6 depicts embodied a broadcast receiver for identifying a delivery in accordance with the DSID.

### DETAILED DESCRIPTION OF THE EMBODIMENTS

Preferable embodiments of the invention provide a method for identifying the delivery system and physical characteristics of the satellite delivery system. A Delivery System Identifier (DSID) is used within a descriptor and the DSID is referred to in a Network Information Table (NIT). The DSID identifies the type of the delivery system (Satellite, Cable, Terrestrial), a band the satellite is transmitting and the position in which the satellite appears on the sky. The NIT is contained in the Service Information (SI). With the method described in these embodiments, the receiver can automatically modify itself to a reception with different parameters. Alternatively, the user can configure the receiver device for the reception with other parameters than currently applied. The discovery of the satellite delivery system parameters does not require a use of the interaction network. Also simple user-friendly configurations are required in the receiver device.

Advantageously, discovery and identification of the delivery system for all services provided can be automatic. Service identifications can be obtained without the use of the interaction network. Few configurations are required in the digital broadcast receiver in order to provide full access to available services. Since the embodiment of the invention uses a centralised identification for delivery systems used defined in the MPEG-2, the invention provides a compatible solution for ATSC systems as well as for DVB systems.

Digital Video Broadcasting (DVB) offers a high bandwidth transmission channel wherein delivery is typically multicast or alternatively unicast. The high bandwidth transmission channel can offer a user of such system various services. Identifications for the various delivery models are necessary to focus on appropriate delivery ways and receivers. A Satellite Delivery System of DVB is preferably applied in the invention. Alternatively, the invention is also applicable in other broadcasting systems enabling satellite distribution such as Advanced Television Systems Committee (ATSC) because such a system provides ability for transmitting delivery information.

The digital broadcast transmission provides a receiver device with huge amount of data information. A nature of the digital broadcast transmission is that the transmission is streaming distribution typically to multiple receivers or alternatively unicast point-to-point distribution to a single receiver. The receiver device should be able to find the relevant delivery system delivering the relevant data information among the huge amount of transmitted data information. The receiver device requires certain parameters in order to be able to receive the relevant service which is intended for or desired by the receiver device. Because the digital broadcast transmission can distribute a lot of data, it can also distribute the parameters which enable the receiver device to discover the delivery system and the properties of the delivery system among transmitted information. These parameters are digitally broadcast to the receiver device. The receiver device recognizes them and can modify itself in accordance with the parameters. Therefore, the receiver device can now start receiving the service, by identifying the relevant delivery system and some delivery properties of the system from the huge amount of data in the broadcast transmission.

Some embodiments of the applied transfer protocol in the invention are based on the methods and systems presented in a specification ISO/IEC 13818-1 Information Technology—Generic Coding of Moving Picture and Associated Audio Information: Systems on pages viii-xii, incorporated herein as a reference. The ISO/IEC 13818-1 defines a Transport Stream (TS) which forms a basis for the service delivery and for the DVB.

Some embodiments of the invention apply Service Information (SI). SI comprises digital data describing the delivery system, content and scheduling/timing of broadcast data streams. SI includes MPEG-2 PSI (Program Specific Information) together with independently defined extensions. Some more technical details of SI can be found from a publication ETSI EN 300 468 v.1.4.1. (2000-11) Digital Video Broadcasting (DVB); Specification for Service Information (SI) in DVB systems, incorporated herein as a reference. Advantageously, delivery system identification can be defined in SI enabling the receiver to be modified to a certain delivery.

Some embodiments of the invention apply Network Information Table (NIT). The NIT conveys information relating to the physical organization of the multiplexes/TSs carried via a given network, and the characteristics of the network itself. The combination of original_network_id and transport_stream_id allows each Transport Stream (TS) to be uniquely identified throughout the application area. Networks are assigned individual network_id values, which serve as unique identification codes for networks. Some more detailed technical details of the NIT can be found from the publication EN 300 468 on page 16. The NIT contains two software loops for tagging descriptors.

Exemplary network_id comprises a 16-bit field which serves as a label to identify the delivery system, about which the NIT informs, from any other delivery system.

Exemplary original_network_id is unique identifier for a network. The original_network_id can be a 16-bit field which serves as a label identifying the network_id of the originating delivery system.

Exemplary transport_stream_id is unique identifier of the TS within an originating network. The transport_stream_id comprises a 16-bit field which serves as a label for identification of the TS from any other multiplex within the delivery system.

Exemplary service_id is unique identifier of a service within the TS. The service_id comprises a 16-bit field which serves as a label to identify a service from any other service within the TS. The service_id can be the same as the program_number in the corresponding program_map_section. The service_id can be contained in a Service Descriptor Table (SDT).

Some embodiments of the invention apply the descriptors. The descriptors are referred to in the NIT. Delivery system descriptors can all have a uniform general definition regarding their structure. Thus, the delivery system descriptors and the descriptor's length facilitate the interchange of these descriptors when a TS is transcoded from one delivery system to another, for example, satellite to cable. Moreover, they may relief the burden when within a certain delivery system transcoding from a certain delivery way to another. More detailed details about the descriptors can be found from the EN 300 468 on page 38. The delivery system descriptors comprises, for example, a satellite_delivery_system_descriptor.

The exemplary satellite_delivery_system_descriptor defines a frequency for the satellite connection. The frequency comprises a 32-bit field giving the 4-bit BCD values specifying 8 characters of the frequency value. For the satellite_delivery_system_descriptor the frequency is typically coded in GHz. The satellite delivery system descriptor defines also orbital_position. The position comprises a 16-bit field giving the 4-bit BCD values specifying 4 characters of the orbital position in degrees. Moreover, the satellite delivery system descriptor defines west_east_flag. The flag comprises a 1-bit field indicating if the satellite position is in the western or eastern part of the orbit. A value “0” indicates the western position and a value “1” indicates the eastern position. In addition, the satellite_delivery_system_descriptor can indicate polarization of the transmitted signal, modulation scheme used, symbol_rate and FEC_inner. More detailed technical information can be found from the EN 300 468 on pages 39 and 40.

The purpose of the Delivery System ID is to simplify the management of services in a digital-tv receiver that can receive service from a mixture of delivery systems.

Some embodiments of the invention apply Delivery System Id (DSID). The purpose of the DSID is to simplify the management of services in a broadcast receiver such as a digital-tv receiver that can receive service from a variety of delivery systems. The DSID uniquely identifies the properties of a delivery system. The DSID provides the receiver device with a possibility to adapt to different delivery systems or different characteristics of the delivery system. The DSID bundles up certain parameters and they are more conveniently accessible than the parameters which are transmitted in the NIT of the DVB-SI or in Virtual Channel Table (VCT) in ATSC—Program and System Information Protocol (ATSC-PSIP). The DSID enables the management of the channel table, for example, existing table indicating the delivery parameters can be merged with a new one. The new DSID can be obtained by receiving a periodical update while obtaining the SI. Alternatively, the DSID can be obtained by a service search or a channel table download with or without a request. The DSID comprises some parameters indicating the delivery. Also, the DSID or information describing values of the DSID can be entered to the receiver. The DSID comprises type of delivery system. The type of the delivery system comprises satellite, cable and terrestrial. The DSID comprises also a band that the satellite is transmitting and a position in which the satellite appears on the sky.

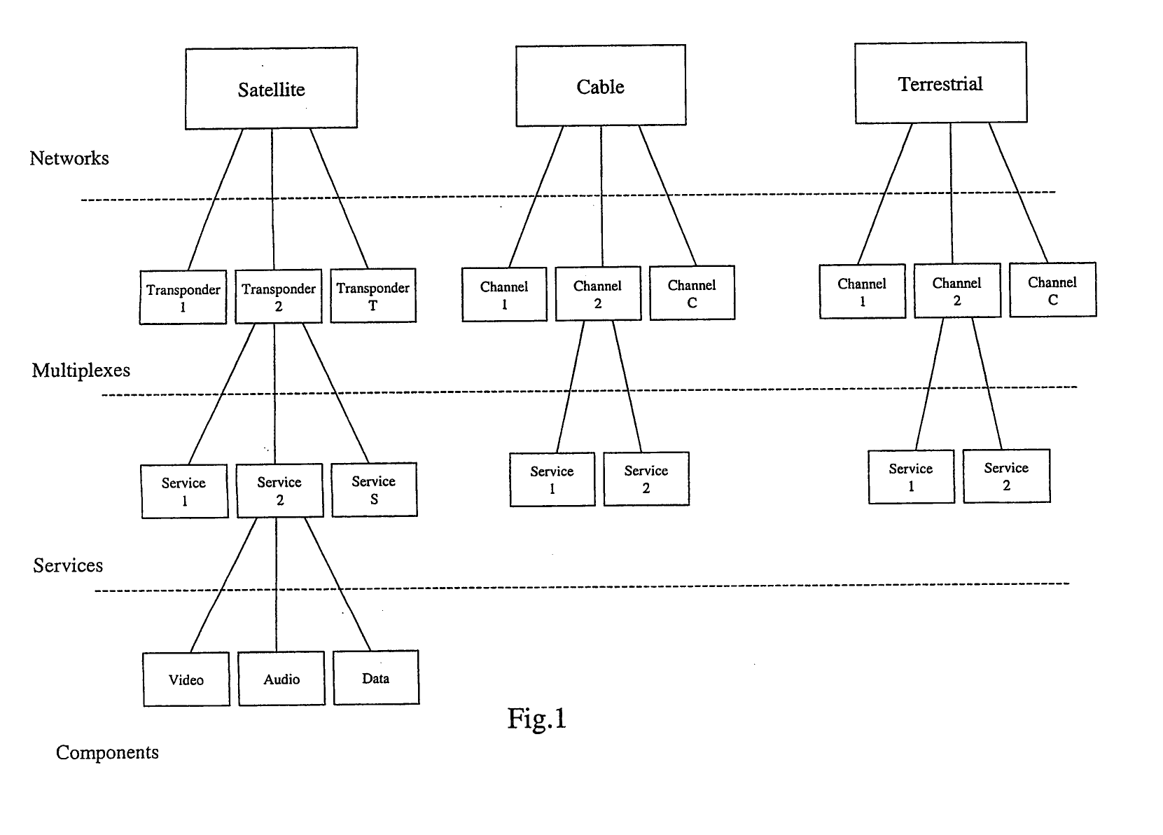

FIG. 1 shows an example of Digital broadcasting service delivery model in accordance with some embodiments of the invention. The delivery system provides the broadcasting with physical medium by which one or more multiplexes are transmitted. The example of FIG. 1 comprises satellite system, cable system and terrestrial system for the delivery ways delivering the transmission eventually to a receiver. For example, satellite system, wide-band coaxial cable, fibre optics, terrestrial channel of at least one emitting point can establish physical delivery basis for the distribution of broadcast services. The network comprises various multiplexes each defining a channel (or transponder for satellite delivery). The multiplexes comprise various services under each channel or transponder, and the services may comprise video and/or audio and/or data. The delivery way can be switched from currently applied or default/home delivery way to another delivery way. For example, a change between delivery media boundaries, e.g. from satellite to cable can take place in processing of delivery system identifier within the service information. Moreover, the delivery way within a physical delivery network system such as the satellite system can be changed. For example, the delivery is changed from currently applied/default satellite to a new satellite.

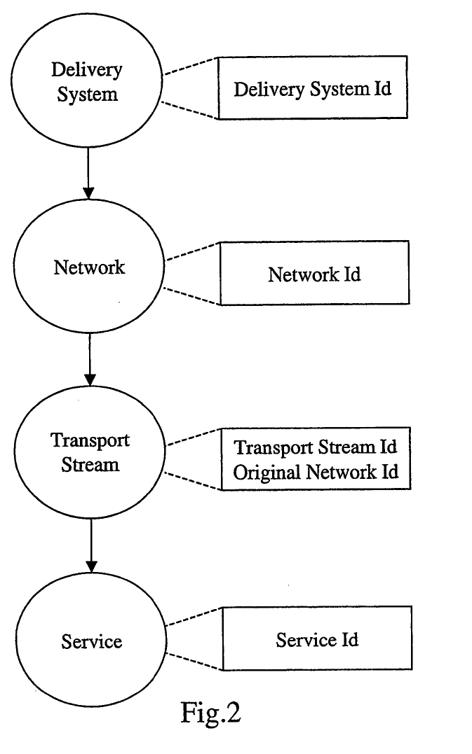

FIG. 2 shows an example of identifier hierarchy in the service delivery system in accordance with an embodiment of the invention. The DSID indicates the delivery system applied in general. The delivery system comprises a currently applied delivery network which is indicated by the network_id. Thus, the network may indicate also the delivery system applied. The broadcast delivery network comprises various Transmission Streams (TS) running. The transport_stream_id and original_network_id together identify the TS. The original_network_id identifies the network_id of the original delivery system. The TS may comprises one or more services running. The service_id identifies the service from any other service within the TS. The service_id serves as the program_number in the corresponding program_map_section. The DSID has one of the upper level hierarchies in the broadcast delivery systems because the DSID indicates, for example, the physical delivery medium or characteristics of the physical delivery medium. The DSID is also one of the frontline parameters that the receiver device, while receiving broadcast transmission, should be aware of. Alternatively, if the broadcast receiver obtains the DSID by other way, for example the user can enter the DSID information, the broadcast receiver is an equipment with a facility to receive the service in a certain way indicated in the DSID.

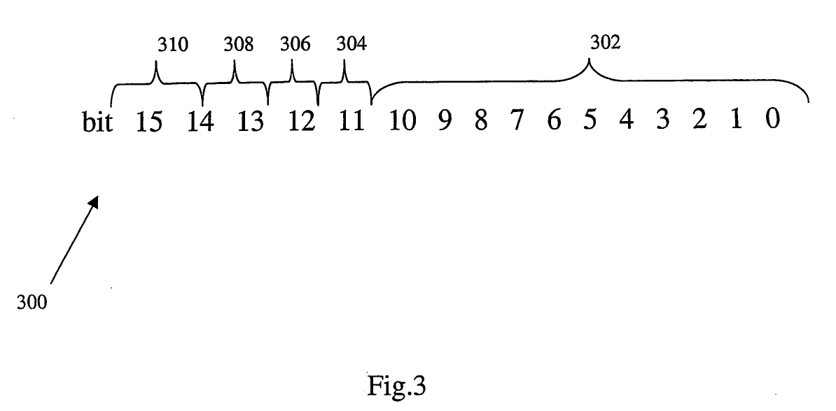

FIG. 3 has been described in the foregoing. In the following, corresponding reference signs have been applied to corresponding parts. Some embodiments of the invention apply the Delivery System Identifier bit line of FIG. 3 for bundling up the possible changes of the delivery system or alterations in the delivery system. The DSID comprises here a bit line 300 of 16-bit length, which is especially applicable to satellite delivery systems. The bit line 300 is accessible by the broadcast receiver.

Considering the inclusion of the DSID into a descriptor is should be noted that a known descriptor consists in general of an eight-bit identifier known as the descriptor_tag, another eight-bit value called descriptor_length that indicates the overall length of the descriptor, and some data. In an exemplary descriptor that contains the DSID, said data may begin with the DSID and continue with a character string where each octet of eight bits represents an alphanumeric character of a plain text name that is associated with the delivery system. Descriptor lengths are expressed in numbers of octets, so to make a DSID bit line 300 comply fully with the exemplary DSID-including descriptor described above, it is advantageous to define the length of the DSID as 16 bits (two octets).

A DSID-including descriptor can also be attached or referred to in the NIT. Thus, the DSID can be added into one (or both) of the two descriptor-loops in the NIT. The DSID is included in the SI and in the TS. Bits 0-10 (302) depict degrees. The degrees depicts satellite positions in degrees: 0.0-180.0. The value of the satellite position in degrees is presented as an integer value that is multiplied with 10 so that the first decimal can be presented with an integer value 0-1800. In hexadecimal presentation the value 0-0x708 is applied. Thus, the orbital position of the satellite in degrees is presented by the bits 302. Bit 11 (304) depicts a west/east flag. The flag comprises a 1-bit field indicating whether the satellite position is in the western or eastern part of the orbit. A value “0” indicates the western position and a value “1” indicates the eastern position. Bit 12 (306) depicts the band which the satellite is applying in transmission. A value “0” for the bit 306 indicates Ku band having an approximate frequency 11 GHz. A value “1” for the bit 306 indicates C band having an approximate frequency 4 GHz. Bit 13 (308) is reserved for future use. Preferably, “0” value for the bit 13 (308) is used. Bits 14-15 (310) depict the type of the delivery system. The type of the delivery system is indicated in the following table.

| Bit 15 | Bit 14 | |
|---|---|---|
| 0 | 0 | Satellite |
| 0 | 1 | Cable |
| 1 | 0 | Terrestrial |
| 1 | 1 | Reserved |

The example of FIG. 3 bundles up both the satellite delivery system parameters and the network delivery system parameters.

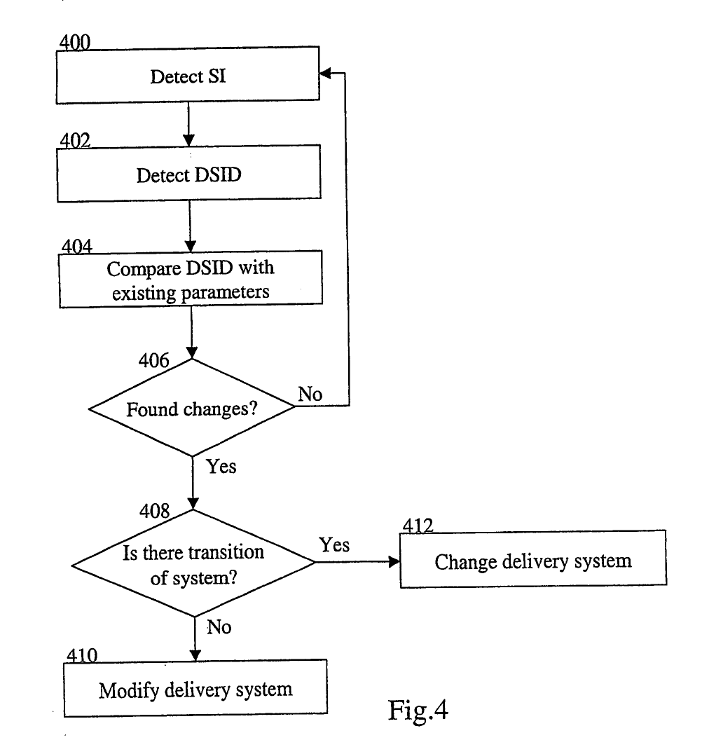

FIG. 4 has been described in the foregoing. In the following, corresponding reference signs have been applied to corresponding parts. FIG. 4 depicts in a form of a flowchart a method for identifying a delivery by receiving DSID from a digital broadcast network in accordance with an embodiment of the invention. A receiver receives the broadcast transmission. In step 400 there is detected the SI. Preferably, a certain satellite system transmission is received but other systems can be applied as well. The received broadcast transmission has also certain characterizing parameters, for example, the applied frequency. The receiver is able to obtain the SI because the receiver contains existing parameters for catching the SI from the broadcast transmission. The DSID is detected in step 402. The DSID is contained in the SI. Preferably, the DSID appears within one kind of descriptor referred to in the NIT of the SI. The DSID is compared with the existing parameters in step 404. The existing parameters for the reception are preferably obtained from the Delivery System Table (DST). In condition 406 there is checked whether there is found an indication of a possible change in the delivery way. Preferably, the DSID is compared with the delivery parameters such as the DST. The comparison can show whether the parameters indicating the delivery system have changed. Thus, a new delivery way could be now available, or the delivery way is about to change. Preferably, the bit line 300 is compared to the values of the parameters in the DST. The DST can be initially defined by the manufacturer when the receiver is made. The user can define some delivery parameters, or some delivery parameters can be received. If no change has been discovered, the broadcast reception continues. If indication of possible changes has been discovered, then details of the changing parameters are being checked. It is being checked whether the change indicates the change of the delivery system in condition 408. If there is an indication that the delivery system changes, the parameters are modified in order to start receiving a transmission via different delivery system in step 412. For example, if there is received the DSID, which points that bits 310 of the bit line 300 show a different delivery system than the currently applied, the receiver recognizes this and start to modify itself for being able to receive the broadcast transmission delivered via a different system. For example, current transmission is applying cable system and the received obtains the bits (310) indicating satellite system (bit values “0 0”), the receiver is now modified that the satellite reception can take place. If there is no indication that the delivery system changes but there are indicated changes in the satellite system, the satellite delivery system is modified in step 410. For example, if the bit 304 shows that different frequency (or different satellite with different frequency) is applied, the receiver is now able to modify the reception parameters for being able to receive the satellite delivery with a different frequency than the currently applied frequency. Preferably, the modified parameters of the delivery system comprise the characteristics of the satellite delivery indicated by bits 302, 304, 306, 308 and 310. The embodied method of FIG. 4 applies a dynamic reception, where the receiver catches the alteration of the delivery way online. For example, the receiver is able to compare the delivery parameters and create new or modify existing reception tables for catching the altered delivery. The altered characteristic of the transmission, for example frequency, can be indicated in currently caught running transmission. Therefore, the receiver is able to continue the reception after the alteration. Thus, the receiver can obtain the parameters that uniquely identify the delivery system.

Introducing the possibility of announcing a changed DSID in the middle of a currently received stream may require defining specific, commonly accepted conditions under which such changing is allowed, because simply changing a DSID in a conventional broadcast system could lead to erroneous operation: the new DSID would not reflect the transmitted stream any longer.

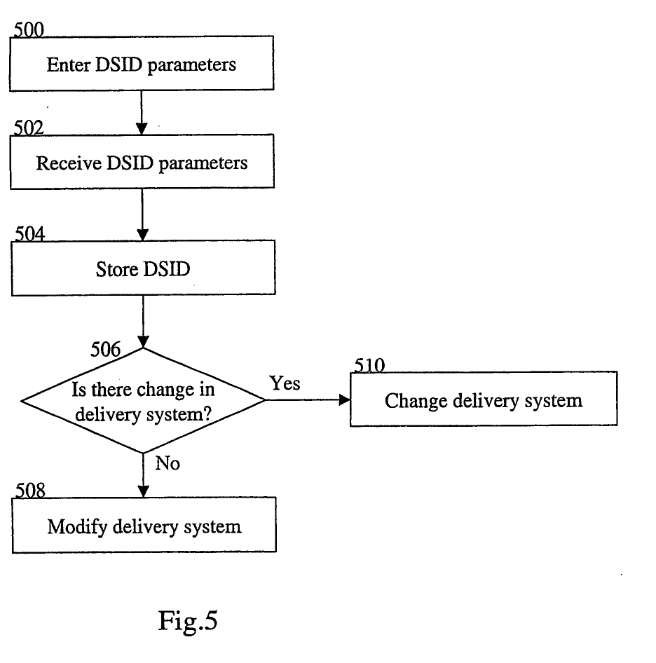

FIG. 5 has been described in the foregoing. In the following, corresponding reference signs have been applied to corresponding parts. FIG. 5 depicts in a form of a flowchart a method for identifying a delivery by receiving a DSID in a digital broadcast receiver device in accordance with a further embodiment of the invention. In some embodiments of the invention the DSID can be manually and conveniently entered to the broadcast receiver thereby enabling the possibly alteration of the delivery system. In step 500 there is entered the DSID. The user of the receiver device can give some information showing a different parameter of the DSID. For example, the user can give information of the new satellite e.g. Thor with both C (4 GHz) and Ku (11 GHz) bands including the name of the satellite and its band. The receiver receives the DSID via a User Interface (UI) (step 502) and stores the DSID in step 504. Preferably, the DSID information is stored into the DST that is stored in the receiver device. The information is now used as a DSID enabling the reception of a certain delivery system. In condition 506 there is being checked whether the delivery system is changed. If it is, according to the DSID the receiver is now capable of receiving the broadcast transmission via a different delivery system (step 510). In step 508 the parameter of the delivery system is modified in order to enable the reception of the delivery system with different properties, for example, the altered frequency. Advantageously, no software upgrade is needed whether the software upgrade would be made by the manufacture of the receiver or not. Thus, the user can enter the parameters that uniquely identify the delivery system. Using the UI, where the user can configure the reception parameters such as the receiver antennae system, new satellites, the delivery system can be entered in a unique way. Moreover, the satellites and/or the delivery systems can be given a defined/arbitrary name. For example, a name for the type or for the frequency of the satellite can be entered. Also, the user can enter a specific reception delivery way and, accordingly, the receiver device starts to the broadcast reception in accordance with the entered delivery way.

Furthermore a channel search on a multi delivery system, i.e. a motorized satellite dish, a 2-4 LNB switched system, etc. is enhanced by providing the user interface where the user can enter the parameters that uniquely identifies the delivery system (i.e. satellite, cable or terrestrial network).

In the example of FIG. 5 some interfaces for entering the delivery identification information constitutes the following. Satellites are edited by entering an access code. When a new satellite has been sent into orbit, or if a pre-programmed satellite is selected, it can be added to the list of satellites. The name of the (new) satellite can be entered. A position (in degree), for example, with the numeric buttons on the remote control is entered. An orientation (east or west) for the satellite is selected. A band (e.g. Ku or C) for the satellite is entered. Moreover, the delivery system can be entered via the UI. The receiver device constructs the DSID from the above information, and the DSID is bundled up.

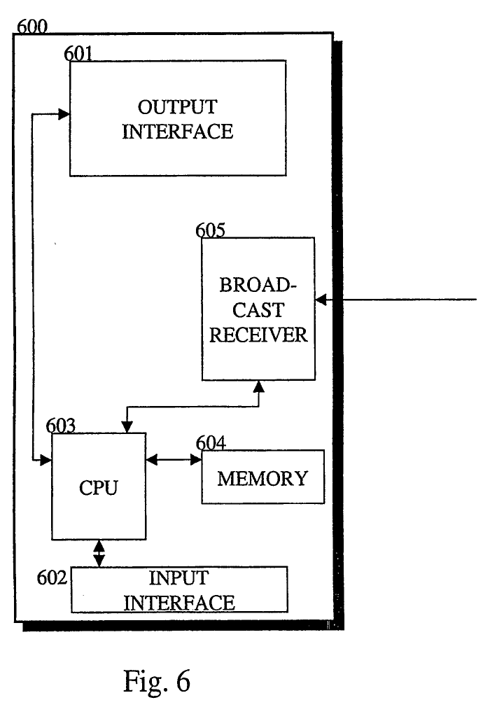

FIG. 6 has been described in the foregoing. In the following, corresponding reference signs have been applied to corresponding parts. FIG. 6 depicts an exemplary block diagram of a receiver device for identifying a delivery in accordance with the DSID. The receiver device 600 of FIG. 6 may be used in the example(s) of FIGS. 4 and/or 5. The receiver device 600 comprises a processing unit CPU 603, a broadcast receiver part 605 and a user interface UI (601, 602). The broadcast receiver part 605 and the user interface UI (601, 602) are coupled with the processing unit CPU 603. The user interface UI (601, 602) comprises a display and a keyboard to enable a user to use the receiver device 600. In addition, the user interface UI (601, 602) comprises a microphone and a speaker for receiving and producing audio signals. The user interface UI (601, 602) may also comprise voice recognition (not shown). The processing unit CPU 603 comprises a microprocessor (not shown), memory 604 and software SW (not shown). The software SW is stored in the memory 604. The microprocessor controls, on the basis of the software SW, the operation of the receiver device 600, such as receiving of the multiplex, the identification of the delivery system, the comparison of the parameters, displaying output in the user interface UI and the reading of inputs received from the user interface UI. The operations are described in the example of FIGS. 4 and/or 5. For example, the software SW comprises means for identifying the signal, means for demodulation, means for identifying the/delivery system, means for identifying characteristics of the delivery system, and means for receiving IP based services. Alternatively, hardware or middleware implementation can be applied (not shown). The receiver device 600 can be a hand-held device which the user can comfortably carry. Advantageously, the receiver device 600 can comprise a cellular mobile phone which contains the broadcast receiver 605 for receiving the broadcast transmission and means for interaction via the cellular mobile phone unit. Therefore, the wireless terminal can also interact with the service providers.

In a further embodiment of the invention, a Mediaterminal (an example of the set-top box) implementation can also have an XML based channel table file format. This format is used when downloading new channel tables and merging with existing channel tables in the terminal.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims. For example, the 16-bit length of the bit line of the DSID is applied. However, the bit length can be increased to 32. It is foreseen that the extension can be used, for example, to bind a delivery system to a tuner/front-end (FE) in multi front-end (FE) receivers. This is beneficial if the delivery systems are different (i.e. cable on FE 1, terrestrial on FE 2).

1. A method for identifying a delivery way for a broadcast transmission delivering services, the method comprising the steps of:
comparing a delivery system identifier with parameters stored in a receiver for receiving the broadcast transmission, wherein the delivery system identifier uniquely identifies the delivery way and reception parameters for a certain delivery way, and
adapting a reception of the broadcast transmission to the delivery way identified by the delivery system identifier in accordance with the comparing step.

2. A method according to claim 1, further comprising the step of detecting the delivery system identifier.

3. A method according to claim 2, wherein the step of detecting comprises the steps of:
detecting service information (SI) within the broadcast transmission,
detecting a network information table (NIT) within the service information,
detecting the delivery system identifier, which is indicated by the network information table (NIT).

4. A method according to claim 1, further comprising the step of entering delivery system identifier information to the receiver for receiving the broadcast transmission.

5. A method according to claim 4, further comprising the step of storing the delivery system information.

6. A method according to claim 1, wherein the broadcast transmission comprises transmission according to Digital Video Broadcasting.

7. A method according to claim 1, wherein the broadcast transmission comprises a terrestrial digital video broadcasting (DVB-T).

8. A method according to claim 1, wherein the broadcast transmission comprises multicast.

9. A method according to claim 1, wherein the broadcast transmission comprises unicast.

10. A method according to claim 1, wherein the broadcast transmission comprises transmission according to Advanced Television Systems Committee (ATSC).

11. A method according to claim 1, wherein the delivery way comprises a delivery system.

12. A method according to claim 11, wherein the delivery system comprises one of a satellite system, a cable system and a terrestrial system.

13. A method according to claim 1, wherein the delivery way comprises a delivery system which is a satellite system, and the reception parameters for the certain delivery way consist of a bit line of 16 bits.

14. A method according to claim 1, wherein the delivery way comprises a delivery system which is a satellite system, and the reception parameters for the certain delivery way consist of an extension bit line of 32 bits.

15. A method according to claim 14, wherein the extension bit line is adapted to bind the delivery system to a front-end in multi-front-end environment.

16. A method according to claim 15, wherein the delivery systems of multifront-end environment are different.

17. A method according to claim 1, wherein the reception parameters for the certain delivery way comprise a band that a satellite system is applying and a position in which the satellite appears on the sky.

18. A method according to claim 1, wherein the delivery system identifier comprises a type of the delivery system, a band that a satellite system is applying, and a position in which the satellite appears on the sky.

19. A method according to claim 17 or 18, wherein the position comprises an orbital position of the satellite in degrees and an eastern/western part of the orbit.

20. A method according to claim 17 or 18, wherein the band comprises at least one of a Ku band operating substantially at a frequency of 11 GHz, and a C band operating substantially at a frequency of 4 GHz.

21. A method according to claim 1, wherein the parameters stored in the receiver comprise Delivery System Table (DST) information.

22. A method according to claim 1, wherein the step of adapting comprises the step of modifying the receiver for switching to a second delivery way.

23. A method according to claim 22, wherein the second delivery way comprises a delivery system other than currently applied delivery system.

24. A method according to claim 1, wherein the step of adapting comprises modifying the receiver for a change in a satellite delivery system.

25. A method according to claim 24, wherein the change in the satellite delivery system comprises changes in at least one of a change in a satellite orbital position in degrees, a change in eastern/western part of the orbit of the satellite, and a change in a satellite band.

26. A method according to claim 1, wherein XML based channel table format is applied in the comparing and adapting steps.

27. A receiver for identifying a delivery way for a broadcast transmission delivering services, the receiver comprising:
means for comparing a delivery system identifier with parameters stored in a receiver for receiving the broadcast transmission, wherein the delivery system identifier uniquely identifies the delivery way and reception parameters for a certain delivery way, and
means for adapting a reception of the broadcast transmission to the delivery way identified by the delivery system identifier in accordance with the comparing.

28. A receiver according to claim 27, further comprising means for interaction with a service provider providing the service.

29. A receiver according to claim 27, wherein the receiver comprises a wireless receiver for receiving broadcast transmission.

30. An interface for entering an identification of a delivery way of a broadcast transmission delivering services, the interface comprising:
a network interface for receiving the broadcast transmission via a certain delivery system in a certain delivery way, and
a user interface for receiving a delivery system identifier information, wherein the delivery system identifier information identifies the delivery system and the certain delivery way to be applied.

31. An interface according to claim 30, wherein the network interface comprises a broadcast receiver for receiving DVB signal.

32. An interface according to claim 30, wherein the delivery system identifier information comprises a type of the delivery system, a band that a satellite system is applying, and a position in which the satellite appears on the sky.

33. An interface according to claim 30, wherein the delivery system identifier information comprises the receiver antennae system, new satellites, and delivery systems.

34. A system for identifying a delivery way of a broadcast transmission delivering services, the system comprising:
delivery systems for transmitting the broadcast transmission of the services,
at least one receiver for catching the broadcast transmission from a certain delivery system in a certain way, and
means for adapting the receiver to a delivery system identifier, wherein the delivery system identifier uniquely identifies the delivery system and reception parameters for the certain way.

35. A system according to claim 34, wherein the broadcast transmission comprises transmission according to Digital Video Broadcasting (DVB).

36. A system according to claim 34, wherein the broadcast transmission comprises a terrestrial digital video broadcasting (DVB-T).

37. A system according to claim 34, wherein the broadcast transmission comprises multicast.

38. A system according to claim 34, wherein the broadcast transmission comprises unicast.

39. A system according to claim 34, wherein the broadcast transmission comprises transmission according to Advanced Television Systems Committee (ATSC).

40. A system according to claim 34, wherein the delivery systems comprise a satellite broadcasting delivery system, a cable distribution delivery system, and a terrestrial broadcast delivery system.

41. A system according to claim 34, wherein the receiver comprises means for catching the delivery system identifier, wherein the delivery system identifier is referred to in a network information table and the network information table is contained in service information within the broadcast transmission.

42. A system according to claim 34, wherein the at least one receiver comprises a wireless broadcast receiver.

43. A computer program product comprising a program of instructions executable by a computing system for processing an identification of the delivery way for broadcast transmission delivering services, the computer program product comprising:
computer program code for causing the system to compare a delivery system identifier with parameters stored in a receiver for receiving the broadcast transmission, wherein the delivery system identifier uniquely identifies the delivery way and reception parameters for a certain delivery way, and
computer program code for causing the system to adapt a reception of the broadcast transmission to the delivery way identified by the delivery system identifier in accordance with the comparing.
